(19) United States
(12) Patent Application Publication
(10) Pub. No.: US 2022/0394814 A1
(43) Pub. Date: Dec. 8, 2022

(54) DISCONTINUOUS TRANSMISSION OR RECEPTION CONFIGURATION METHOD AND USER EQUIPMENT

(71) Applicant: VIVO MOBILE COMMUNICATION CO., LTD., Dongguan (CN)

(72) Inventors: Siqi LIU, Dongguan (CN); Zichao JI, Dongguan (CN); Xiaodong YANG, Dongguan (CN); Wei BAO, Dongguan (CN); Shixiao LIU, Dongguan (CN)

(73) Assignee: VIVO MOBILE COMMUNICATION CO., LTD., Dongguan (CN)

(21) Appl. No.: 17/889,347

(22) Filed: Aug. 16, 2022

Related U.S. Application Data
(63) Continuation of application No. PCT/CN2021/077247, filed on Feb. 22, 2021.

(30) Foreign Application Priority Data
Feb. 21, 2020 (CN) 202010109221.8

(51) Int. Cl. H04W 76/28

(52) U.S. Cl. CPC H04W 76/28

(57) ABSTRACT

A discontinuous transmission or reception configuration method includes: acquiring target configuration information for configuring a target discontinuous transmission or reception mode on at least one carrier; and performing transmission according to the target configuration information; where the target discontinuous transmission or reception mode includes at least one of a Uu discontinuous transmission or reception mode used by a UE with a sidelink resource allocation mode and a sidelink discontinuous transmission or reception mode. Also disstopd are user equipment for configuring a discontinuous transmission or reception mode and a readable storage medium storing a computer program of the discontinuous transmission or reception configuration method. The target discontinuous transmission or reception mode can meet a sidelink service requirement and a Uu service requirement at the same time, and improve the energy efficiency of a communication system.

### CROSS-REFERENCE TO RELATED APPLICATIONS

This application is a continuation of International Application No. PCT/CN2021/077247, filed on Feb. 22, 2021, which claims priority to Chinese Patent Application No. 202010109221.8, filed on Feb. 21, 2020. The entire contents of each of the above-identified applications are expressly incorporated herein by reference.

### TECHNICAL FIELD

The present disclosure relates to the field of communication technologies, and in particular, to a discontinuous transmission or reception configuration method and user equipment.

### BACKGROUND

Currently, a sidelink system mainly supports two resource allocation modes: a scheduled resource allocation mode (usually referred to as mode-1) and an autonomous resource selection mode (usually referred to as mode-2). The scheduled resource allocation mode is controlled by a network side device and a resource is allocated to each UE. In the autonomous resource selection mode, a resource is selected by UE autonomously.

A sidelink service requirement is usually different from a Uu service requirement, and in mode-1, a user also needs to monitor DCI (that is, SL DCI) for scheduling a sidelink resource. Therefore, before a base station can send SL DCI for scheduling retransmission, a sidelink transmission and feedback process is required. In this way, SL UE cannot directly reuse a Uu Discontinuous Reception (DRX) mechanism in the related art.

### SUMMARY

Embodiments of the present disclosure provide a discontinuous transmission or reception configuration method and user equipment, to configure a discontinuous transmission or reception mode for SL UE.

According to a first aspect, an embodiment of the present disclosure provides a discontinuous transmission or reception configuration method, applied to first UE and including:

acquiring target configuration information on at least one carrier; and performing transmission according to the target configuration information; where the target configuration information is used to configure a target discontinuous transmission or reception mode, the target discontinuous transmission or reception mode includes at least one of a first discontinuous transmission or reception mode and a sidelink discontinuous transmission or reception mode, and the first discontinuous transmission or reception mode is: a Uu discontinuous transmission or reception mode used by a UE with a sidelink resource allocation mode.

According to a second aspect, an embodiment of the present disclosure provides UE, where the UE is first UE and includes: an acquisition module, configured to acquire target configuration information on at least one carrier; and a transmission module, configured to perform transmission according to the target configuration information acquired by the acquisition module; where the target configuration information is used to configure a target discontinuous transmission or reception mode, the target discontinuous transmission or reception mode includes at least one of a first discontinuous transmission or reception mode and a sidelink discontinuous transmission or reception mode, and the first discontinuous transmission or reception mode is: a Uu discontinuous transmission or reception mode used by a UE with a sidelink resource allocation mode.

According to a third aspect, an embodiment of the present disclosure provides UE, where the UE is first UE and includes: a processor, a memory, and a computer program stored in the memory and executable on the processor, and when the computer program is executed by the processor, steps of the discontinuous transmission or reception configuration method provided in the first aspect are implemented.

According to a fourth aspect, an embodiment of the present disclosure provides a computer-readable storage medium, where the computer-readable storage medium stores a computer program, and when the computer program is executed by a processor, steps of the discontinuous transmission or reception configuration method provided above are implemented.

In the embodiments of the present disclosure, the target configuration information acquired by the first UE is used to configure the target discontinuous transmission or reception mode, and the target discontinuous transmission or reception mode includes the first discontinuous transmission or reception mode (that is, the Uu discontinuous transmission or reception mode used by a UE with a sidelink resource allocation mode) and the sidelink discontinuous transmission or reception mode. Therefore, the target discontinuous transmission or reception mode may be configured for the first UE based on the target configuration information, so as to perform transmission in the target discontinuous transmission or reception mode. This can meet a sidelink service requirement and a Uu service requirement at the same time, and improve the energy efficiency of a communication system.

### BRIEF DESCRIPTION OF DRAWINGS

FIG. 1 is a schematic structural diagram of a communications system according to an embodiment of the present disclosure;

FIG. 2 is a flowchart of a discontinuous transmission or reception configuration method according to an embodiment of the present disclosure;

FIG. 3 is a schematic structural diagram of UE according to an embodiment of the present disclosure; and

FIG. 4 is a schematic structural diagram of a terminal device according to an embodiment of the present disclosure.

### DETAILED DESCRIPTION

The following describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

The following describes technical terms in the embodiments of the present disclosure.

1. Discontinuous Transmission or Reception

“Discontinuous transmission or reception” in the embodiments of the present disclosure includes discontinuous reception and/or discontinuous sending. The discontinuous reception refers to “DRX” in the related art.

Regarding the “DRX” in the related art, both Long Term Evolution (LTE) and NR introduce a DRX mechanism, and power consumption of UE is reduced by configuring an active time and an inactive time of DRX. Generally, an on duration period is the active time of DRX. If there is no scheduling, the UE enters the inactive time of a DRX cycle after the on duration period. Usually, during DRX configuration, parameters such as onDurationTimer, drx-InactivityTimer, drx-RetransmissionTimer, and longDRX-CycleStartOffset are configured.

After the UE is configured with DRX, if decoding of data sending or reception fails, the UE needs to enter the active time to monitor a control channel and wait for retransmission scheduled by the network. During the on duration period, if the UE is scheduled to receive or send data in a slot, it is highly possible that the UE continues to be scheduled in next several slots. Therefore, the timer drx-InactivityTimer is started or restarted each time the UE is scheduled to initially transmit data, and the UE remains in the active state until the timer expires.

For downlink data reception, the UE starts a downlink Round Trip Time (RTT) timer for a corresponding Hybrid Automatic Repeat reQuest (HARQ) process (HARQ RTT Timer) after receiving downlink data transmission indicated by a PDCCH. If data of the HARQ process is not successfully decoded after the HARQ RTT Timer expires, the UE starts a retransmission timer (drx-RetransmissionTimer), enters the active state to monitor a PDCCH, and waits for transmission scheduled by the network.

For uplink data sending, the UE starts an uplink RTT timer for a corresponding HARQ process (HARQ RTT Timer) after receiving uplink data transmission indicated by a PDCCH. After the HARQ RTT timer expires, the UE starts a retransmission timer (drx-ULRetransmissionTimer), enters the active state to monitor a PDCCH, and waits for transmission scheduled by the network.

2. Sidelink

An LTE system can support sidelink for direct data transmission between UEs without a network device. The UE sends Sidelink Control Information (SCI) through a Physical Sidelink Control Channel (PSCCH), and schedules Physical Sidelink Shared Channel (PSSCH) transmission to send data. The transmission is performed in a broadcast manner, and a receive end does not feed back, to a transmit end, whether the reception is successful.

An LTE sidelink design supports two resource allocation modes: a scheduled resource allocation mode (usually referred to as mode-1) and an autonomous resource selection mode. The scheduled resource allocation mode is controlled by a network side device and a resource is allocated to each UE. In the autonomous resource selection mode, a resource is selected by UE autonomously.

3. Sidelink Feedback

Sidelink feedback refers to receiving or sending a sidelink HARQ-ACK on a sidelink.

TX UE is used as an example. TX UE sends a signal to RX UE on a sidelink, the RX UE receives the signal and feeds back a sidelink HARQ-ACK to the TX UE on a PSFCH, and then the TX UE reports a sidelink HARQ-ACK to a base station. A period of the PSFCH is N, where N=1, 2, or 4 logical slots (sidelink slots). An actual distance between N sidelink slots may be greater than a slot duration corresponding to N physical slots.

Assuming that physical slots 2 and 4 of 5 physical slots are used for SL, logical slot numbers of these two SL slots are the SL slot numbers 1 and 2. In this case, an actual distance between the logical slots 1 and 2 is 2 physical slots, which is greater than the duration corresponding to 1 slot.

4. Other Terms

It should be noted that “/” in this specification represents “or”. For example, A/B may indicate A or B; “and/or” in this specification merely describes an association relationship between associated objects, and indicates that there may be three relationships. For example, A and/or B may indicate three cases: only A exists, both A and B exist, and only B exists.

It should be noted that, for ease of clearly describing the technical solutions in the embodiments of this application, in the embodiments of this application, the words “first”, “second”, and the like are used to distinguish between same or similar items with basically the same functions. A person skilled in the art may understand that the words “first”, “second”, and the like do not limit a quantity and an execution sequence. For example, first UE and second UE are used to distinguish between different UEs, but are not used to describe a particular sequence of the UEs.

It should be noted that, in the embodiments of the present disclosure, words such as “exemplary” or “for example” are used to indicate an example, an instance, or descriptions. Any embodiment or design solution described as “exemplary” or “for example” in the embodiments of the present disclosure should not be construed as being more preferred or advantageous than other embodiments or design solutions. To be precise, the use of the term such as “exemplary” or “for example” is intended to present a related concept in a specific manner.

It should be noted that, in the embodiments of this application, “of”, “relevant”, and “corresponding” may be used in a mixed manner. It should be noted that, when a difference is not emphasized, meanings to be expressed by them are the same. In the embodiments of this application, “multiple” means two or more.

The following describes the solutions provided in the embodiments of the present disclosure with reference to the accompanying drawings.

The technical solutions provided in the present disclosure may be applied to various communications systems, for example, a 5G communications system, a future evolved system, or a plurality of communications fusion systems. There may be multiple application scenarios, for example, Machine to Machine (M2M), D2M, macro-micro communication, enhance Mobile BroadBand (eMBB), ultra Reliable & Low Latency Communication (uRLLC), and massive Machine Type Communication (mMTC). These scenarios include, but not limited to: scenarios such as communication between UE and UE, communication between network side devices, or communication between a network side device and UE. The embodiments of the present disclosure may be applied to communication between a network side device and UE, communication between UE and UE, or communication between network side devices in a 5G communications system.

FIG. 1 is a schematic structural diagram of a communications system according to an embodiment of the present disclosure. As shown in FIG. 1, the communications system includes at least one network side device 100 (only one network side device is shown in FIG. 1) and one or more UE 200 connected to each network side device 100.

The network side device 100 may be a base station, a core network device, a Transmission and Reception Point (TRP), a relay station, an access point, or the like. The network side device 100 may be a Base Transceiver Station (BTS) in a Global System for Mobile communication (GSM) or a Code Division Multiple Access (CDMA) network, may be an NodeB (NB) in Wideband Code Division Multiple Access (WCDMA), or may be an evolutional NodeB (eNB or eNodeB) in LTE. The network side device 100 may also be a wireless controller in a Cloud Radio Access Network (CRAN) scenario. The network side device 100 may be a network side device in the 5G communications system or a network side device in a future evolved network. However, the use of words does not constitute a limitation on the present disclosure.

The UE 200 may be a terminal device. The terminal device may be a wireless terminal device or a wired terminal device. The wireless terminal device may be a device that provides voice and/or other service data connectivity for a user, a handheld device with a wireless communication function, a computing device, another processing device connected to a wireless modem, an in-vehicle device, a wearable device, a terminal device in a future 5G network, a terminal device in a future evolved PLMN network, or the like. The wireless terminal device may communicate with one or more core networks by using a Radio Access Network (RAN). The wireless terminal device may be a mobile terminal device, such as a mobile phone (or referred to as a “cellular” phone) and a computer with a mobile terminal device. For example, the wireless terminal device may be a portable, pocket-sized, handheld, computer built-in, or in-vehicle mobile apparatus that exchanges voice and/or data with a radio access network, and/or a device such as Personal Communication Service (PCS) phone, a cordless phone, a Session Initiation Protocol (SIP) phone, a Wireless Local Loop (WLL) station, or a Personal Digital Assistant (PDA). The wireless terminal device may also be a mobile device, User Equipment (UE), a UE terminal device, an access terminal device, a wireless communications device, a terminal device unit, a terminal device station, a mobile station, a mobile console, a remote station, a remote terminal, a subscriber unit, a subscriber station, a user agent, a terminal device apparatus, or the like. In an example, in the embodiments of the present disclosure, a mobile phone is shown as an example of the terminal device in FIG. 1.

The solutions provided by the embodiments of the present disclosure are applicable to a scenario in which sending UE sends feedback information to a network side device, and a scenario in which receiving UE sends feedback information to a network side device.

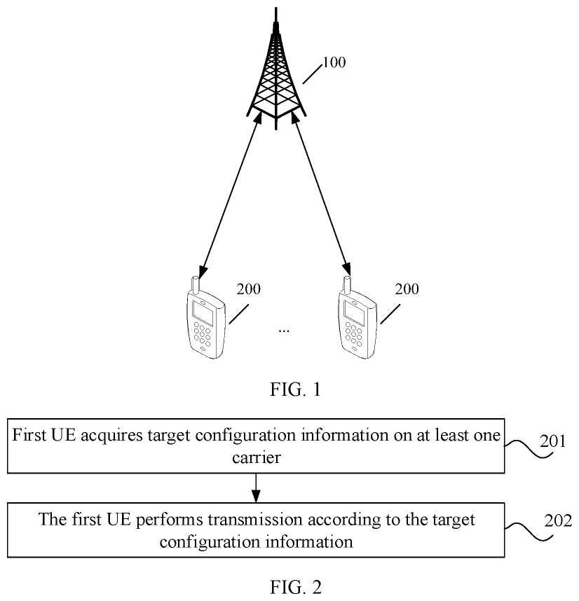

FIG. 2 is a schematic flowchart of a discontinuous transmission or reception configuration method according to an embodiment of the present disclosure. As shown in FIG. 2, the discontinuous transmission or reception configuration method may include:

Step 201: First UE acquires target configuration information on at least one carrier.

Step 202: The first UE performs transmission according to the target configuration information.

In this embodiment of the present disclosure, the target configuration information is used to configure a target discontinuous transmission or reception mode, the target discontinuous transmission or reception mode includes at least one of a first discontinuous transmission or reception mode and a sidelink discontinuous transmission or reception mode, and the first discontinuous transmission or reception mode is: a Uu discontinuous transmission or reception mode used by a UE with a sidelink resource allocation mode.

It should be noted that the Uu discontinuous transmission or reception mode refers to a discontinuous transmission or reception mode used for a Uu PDCCH; and Uu refers to a Uu interface between the UE and the network side device. The first Uu discontinuous transmission or reception mode refers to a Uu discontinuous transmission or reception mode of the first UE used by a UE with a sidelink resource allocation mode, where the Uu interface of the first UE using the sidelink resource allocation mode can be considered as a Uu interface scheduled on a sidelink. Therefore, the first Uu discontinuous transmission or reception mode may be referred to as a scheduled Uu discontinuous transmission or reception mode for short. The sidelink discontinuous transmission or reception mode refers to a discontinuous transmission or reception mode used on a sidelink.

Exemplarily, the sidelink resource allocation mode may be a mode 1 mode on a sidelink, or may be a derivative mode when another network side device schedules a sidelink, which is not limited in this embodiment of the present disclosure.

For example, in this embodiment of the present disclosure, if the target configuration information is configuration information of the scheduled Uu discontinuous transmission or reception mode, the carrier is a Uu carrier; if the target configuration information is configuration information of the sidelink discontinuous transmission or reception mode, the carrier is a sidelink carrier.

For example, in this embodiment of the present disclosure, the target configuration information is configured by a network side device for the first UE, or specified by a protocol, or preconfigured, or indicated by second UE, or negotiated by UEs.

For example, in this embodiment of the present disclosure, the target configuration information is carried on at least one of the following signaling: configuration signaling of the Uu discontinuous transmission or reception mode, configuration signaling of the first discontinuous transmission or reception mode, and configuration signaling of the sidelink discontinuous transmission or reception mode. Exemplarily, if the target configuration information is carried on the configuration signaling of the Uu discontinuous transmission or reception mode, it can be considered that the configuration signaling corresponding to the Uu discontinuous transmission or reception mode in the related art includes configuration information of the first discontinuous transmission or reception mode or configuration information of the sidelink discontinuous transmission or reception mode. That is, it can be considered that at least a part of the Uu discontinuous transmission or reception mode in the related art is reused.

For example, in this embodiment of the present disclosure, the target configuration information includes at least one of the following: at least one wait-for-retransmission timer (that is, an RTT timer) and at least one retransmission timer (that is, a retransmission timer). It should be noted that the above retransmission may be sending or receiving a same Transport Block (TB) again.

Exemplarily, the target configuration information is used to configure one RTT timer or multiple RTT timers, and/or the target configuration information is also used to configure one retransmission timer or multiple retransmission timers. Timing durations of the multiple RTT timers may be the same or different. Similarly, timing durations of the multiple retransmission timers may be the same or different. This may be determined according to actual usage requirements and is not limited in this embodiment of the present disclosure.

Exemplarily, the first UE may use a configured timer, may configure to determine a timer, or may dynamically determine a timer according to actual scheduling. This may be determined according to actual usage requirements and is not limited in this embodiment of the present disclosure.

For example, the timing time of the timer in this embodiment of the present disclosure is logical time or physical time.

For example, in this embodiment of the present disclosure, the target configuration information is used to configure at least one of a wait-for-retransmission timer and a retransmission timer for each target object or each group of target objects. The target object includes at least one of the following: a carrier, a BandWidth Part (BWP), a resource pool, a link, a transmission, a feedback mechanism, a sidelink HARQ process, a downlink HARQ process, a sidelink grant, a destination ID, and a source ID.

Exemplarily, the link may be a higher layer signaling link (for example, a PG5 RRC link, a sidelink RRC link, or a service link), or may be a transmission, such as multicast, unicast, or broadcast. It should be noted that multicast does not necessarily mean that there is certainly a signaling link. In some embodiments, at least one of a wait-for-retransmission timer and a retransmission timer may be configured for each link ID or each group of link IDs.

Exemplarily, the sidelink grant includes: a configured sidelink grant (configured sidelink grant) and/or a dynamic sidelink grant, where the dynamic sidelink grant may be Downlink Control Information (DCI) for scheduling sidelink resources (abbreviated as SL DCI).

It should be noted that the above scheduling of sidelink resources is generalized scheduling. Exemplarily, the scheduling of sidelink resources may include: scheduling sidelink transmissions, activating sidelink resources, or deactivating sidelink resources.

It should be noted that, in this embodiment of the present disclosure, one or more RTT timers and/or one or more retransmission timers may be configured for one or one group. For example, three RTT timers are configured for one HARQ process, respectively corresponding to the numbers of transmissions of 1, 2, and 3. The user determines a timer from the three timers according to the number of transmissions of the dynamic scheduling.

For example, in this embodiment of the present disclosure, the wait-for-retransmission timer is a first wait-for-retransmission timer, and/or the retransmission timer is at least one of first retransmission timers; where the first wait-for-retransmission timer and the first retransmission timer are timers corresponding to the first discontinuous transmission or reception mode. The first wait-for-retransmission timer may be a waiting SL bs-scheduled HARQ retransmission timer (abbreviated as an SL bs-scheduled RTT timer), for example, drx-HARQ-RTT-TimerSL-bs-scheduled. The first retransmission timer may be an SL bs-scheduled retransmission timer (abbreviated as an SL bs-scheduled Re timer), for example, drx-Retransmission Timer SL-bs-scheduled.

It should be noted that since the sidelink service and the Uu service are different, the first wait-for-retransmission timer and the first retransmission timer are different from uplink UL and downlink DL timers. Besides, delays of sidelink transmission, sidelink feedback and reporting to the base station need to be considered for sidelink timing. Therefore, sidelink timing is longer than that of the timer corresponding to Uu.

Exemplarily, for the first discontinuous transmission or reception mode, when the SL TB transmission of a sidelink HARQ process fails in the mode-1, the UE may assume that the base station resends SL DCI to schedule retransmission at least after the “waiting SL mode-1 HARQ retransmission timer (that is, the first wait-for-retransmission timer)” expires. Therefore, when the “waiting SL mode-1 HARQ retransmission timer” runs, the UE does not need to monitor the SL DCI. When the “waiting SL mode-1 HARQ retransmission timer” expires and data corresponding to the sidelink HARQ process is not successfully decoded, the UE starts a “SL mode-1 retransmission timer (that is, the first retransmission timer)” for the HARQ process. When the “SL mode-1 retransmission timer” runs, the UE monitors the SL DCI for sidelink HARQ retransmission. This requires that the base station schedules sidelink HARQ retransmission after the “SL mode-1 retransmission timer” expires, and allocates a radio resource for the retransmission. In this way, power consumption can be reduced through the combination of the above two timers.

For example, in this embodiment of the present disclosure, the timing of the wait-for-retransmission timer and/or the timing of the retransmission timer is related to at least one of the following:

a carrier, a BWP, a resource pool, a transmission type, a feedback mechanism, the maximum number of transmissions of the sidelink grant, the number of resources of the sidelink grant, the actual number of transmissions of the sidelink grant, the minimum time interval K between a Physical Sidelink Feedback CHannel (PSFCH) corresponding to a sidelink resource and a corresponding Physical Sidelink Shared CHannel (PSSCH), a transmission or reception period N of the PSFCH corresponding to the sidelink resource, the maximum number of transmissions scheduled by SCI, the actual number of transmissions scheduled by SCI, the maximum number of retransmissions, a resource preemption parameter, a priority, a communication range, a delay, reliability, a Channel Busy Ratio (CBR), a Channel occupancy Ratio (CR), a time range occupied by the sidelink resource, sidelink resource configuration information, sidelink resource indication information, Physical Uplink Control CHannel (PUCCH) configuration information, and PUCCH indication information.

Exemplarily, the target configuration information may configure one or more wait-for-retransmission timers, and/or one or more retransmission timers. The timing duration of each timer is related to one or more of the above parameters, that is, timing durations of the above one or more wait-for-retransmission timers can be the same or different. Similarly, timing durations of the above one or more retransmission timers can be the same or different. In an embodiment, the timing duration of the timer may be determined according to the configuration of the resource pool. For example, it is assumed that an RTT timer is configured for each HARQ process and the duration of the RTT timer is related to the PSFCH cycle of the resource pool. It is assumed that the PSFCH cycles of resource pools 1 and 2 are 2 and 4 respectively. The duration of the timer when the HARQ process is used for transmission in resource pool 1 is different from that of the timer when the HARQ process is used for transmission in resource pool 2, that is, durations of the timer change accordingly.

Exemplarily, the transmission type includes: broadcast or multicast or unicast.

Exemplarily, the feedback mechanisms includes the following two types: there is no feedback and feedback is required. That feedback is required includes option 1 (feedback without connection) and option 2 (feedback with connection). For option 1, if decoding is unsuccessful, NACK is fed back; for option 2, if decoding is successful, ACK is fed back and if decoding is unsuccessful, NACK is fed back. For example, broadcasting does not require sidelink feedback. In this case, a duration of the timer may be shorter than that of a timer corresponding to transmission requiring sidelink feedback.

Exemplarily, the duration of the timer is related to the scheduled resource pool or the resource pool of the sidelink grant. This is because many transmission parameters such as the above K, the above N, the maximum number Nmax of transmissions of the sidelink grant, and the maximum number of retransmissions are all configured for each resource pool. Therefore, the duration of the timer is also related to the resource pool. In the above example of two resource pools (resource pool 1 and resource pool 2), an RTT timer is configured for each resource pool. The RTT timer is related to Nmax. When Nmax of resource pool 1 is 2 and Nmax of resource pool 2 is 3, durations of the two timers corresponding to the two resource pools are different.

Exemplarily, the number of transmissions may be the number of transmissions of data, or may be the number of transmissions of other signals (for example, a reference signal RS, a sequence, or control signaling) other than data.

Exemplarily, the maximum number of retransmissions plus 1 is the maximum number of transmissions.

Exemplarily, the number of transmissions actually scheduled by the SCI may be considered as the number of resources included in the SCI.

Exemplarily, the sidelink resource configuration information may include: configuration information of at least one of a PSCCH, a PSSCH, and a PSFCH.

Exemplarily, the sidelink resource configuration information may further include: an SL DCI indication, or SCI indication, or sidelink configured grant configuration, or the like.

Exemplarily, the resource preemption parameter may be used to indicate at least one of the following: the number of times of performing preemption, the number of times of being preempted, the maximum number of times of being preempted, and the maximum number of times of performing preemption. For example, as the number of times of performing preemption is larger, the duration of the timer is longer; or as the number of times of performing preemption is smaller, the duration of the timer is shorter.

Exemplarily, as the priority is higher, the duration of the timer is shorter, and as the priority is lower, the duration of the timer is longer. In some embodiments, as the priority is higher, the duration of the timer is longer, and as the priority is lower, the duration of the timer is shorter.

Exemplarily, as the communication range is required to be longer, the duration of the timer is longer, and as the communication range is required to be shorter, the duration of the timer is shorter. In some embodiments, as the communication range is required to be shorter, the duration of the timer is longer, and as the communication range is required to be longer, the duration of the timer is shorter.

Exemplarily, as the delay is required to be shorter, the duration of the timer is shorter, and as the delay is required to be longer, the duration of the timer is longer. In some embodiments, as the delay is required to be shorter, the duration of the timer is longer, and as the delay is required to be longer, the duration of the timer is shorter.

Exemplarily, as the reliability is required to be higher, the duration of the timer is longer, and as the reliability is required to be lower, the duration of the timer is shorter. In some embodiments, as the reliability is required to be higher, the duration of the timer is shorter, and as the reliability is required to be lower, the duration of the timer is longer.

Exemplarily, as the CBR is higher, the duration of the timer is longer, and as the CBR is lower, the duration of the timer is shorter. In some embodiments, as the CBR is higher, the duration of the timer is shorter, and as the CBR is lower, the duration of the timer is longer.

Exemplarily, as the CR is higher, the duration of the timer is longer, and as the CR is lower, the duration of the timer is shorter. In some embodiments, as the CR is higher, the duration of the timer is shorter, and as the CR is lower, the duration of the timer is longer.

Exemplarily, the SL bs-scheduled Retimer is used as an example, and each SL bs-scheduled Retimer is related to at least one of K, N, the maximum number of transmissions Nmax scheduled by SL DCI, the number Nactual of SL transmissions actually scheduled by SL DCI, the maximum number Nmax SCI of SL transmissions scheduled by SCI, the actual number Nactual_SCI of transmissions scheduled by the SCI, the maximum number N_retx of retransmissions, and the like.

For example, in this embodiment of the present disclosure, the time range occupied by the sidelink resource is W slots or W milliseconds or W subframes, or the time range occupied by the sidelink resource is related to the maximum number of transmissions of the sidelink grant, or the time range occupied by the sidelink resource is a time resource span occupied by actual transmission of the sidelink grant, or the time range occupied by the sidelink resource is related to the maximum number of transmissions scheduled by the SCI, or the time range occupied by the sidelink resource is a time resource span occupied by the resource actually scheduled by the SCI; where W is a preset value.

Exemplarily, the value of the time range occupied by the sidelink resource may be 32 slots.

Exemplarily, the value of the time range occupied by the sidelink resource may be related to the maximum number Nmax of transmissions scheduled by the SL DCI. For example, when Nmax=2, the value of the time range occupied by the sidelink resource is equal to the preset value 1; when Nmax=3, the value of the time range occupied by the sidelink resource is equal to the preset value 2. It should be noted that the preset value 1 and the preset value 2 may be preconfigured or predefined.

An example is provided for the time range occupied by the sidelink resource and the time resource span occupied by the sidelink transmission actually scheduled by the SL DCI. In an example, SL DCI actually schedules 3 resources, and these 3 resources are located in slot 1, slot 2, and slot 5 respectively. Then, the value of the time range occupied by the SL resource=5−1+1=5 slots. In this case, the value of timer changes along with an actual status of each time of scheduling.

For example, in this embodiment of the present disclosure, a duration of the first wait-for-retransmission timer corresponding to the first discontinuous transmission or reception mode is not less than any one of the following: a duration from a time of the sidelink grant to a time of PUCCH transmission, or a duration from a time of activation signaling corresponding to the sidelink grant to a time of PUCCH transmission, or a duration from a time of the first or last transmission of the sidelink grant to a time of PUCCH transmission, or a duration from a time of a PSFCH corresponding to the first or last transmission of the sidelink grant to a time of PUCCH transmission.

Exemplarily, the duration of the first wait-for-retransmission timer>=y1+time range occupied by sidelink resource+K+N−1+y2, or the duration of the first wait-for-retransmission timer>=y1+time range occupied by the sidelink resource+K+y2, or the duration of the first wait-for-retransmission timer>=y2.

The above K is the minimum time interval between the PSFCH corresponding to the sidelink resource and the corresponding PSSCH, the above N is a transmission cycle of the PSFCH corresponding to the sidelink resource, the above y1 is the time interval between the sidelink grant and the first sidelink resource allocated in the sidelink grant, and the above y2 is the time interval between a PSFCH corresponding to the last sidelink resource allocated in the sidelink grant and a corresponding PUCCH.

Exemplarily, the duration of the first wait-for-retransmission timer>=y1+time range occupied by the sidelink resource+preset interval M+y2. In an example, the preset interval M may be an interval or the maximum interval between the last PSSCH and a PUCCH corresponding to the last PSSCH. It should be noted that the above M may be a preset value, or may be a value determined according to actual usage requirements, which is not limited in the embodiments of the present disclosure. For example, the maximum value of the above M may be K+N−1, and the minimum value of the above M may be K.

For example, y1=1, y2=1, N=2, and K=2. In this case, the duration of the first wait-for-retransmission timer may be 1+1+2+2=6 slots. For example, the user may wait for at least 6 slots before continuing to monitor SL DCI.

Exemplarily, for the TX UE, that is, for a case in which the SL DCI schedules the transmission of the TX UE, if the TX UE feeds back the sidelink HARQ-ACK, the duration of the first wait-for-retransmission timer needs to at least include: a duration occupied by a process of SL DCI->TX UE transmits SL->RX UE PSFCH->TX UE sends a PUCCH->gNB. For example, the duration of the SL bs-scheduled RTT timer>=y1+time range occupied by the sidelink resource+K+N−1+y2.

In an example, the process of SL DCI->TX UE transmits SL->RX UE PSFCH->TX UE sends a PUCCH->gNB includes: the TX UE receives SL DCI, the TX UE performs SL transmission according to the SL DCI (sends a PSSCH and a PSCCH), the RX UE sends a PSFCH for feedback after receiving the transmission, and the TX UE receives the PSFCH and determines to send feedback information, and then sends the feedback information to the base station on a PUCCH.

In an example, in a case in which the SL DCI schedules sending of TX UE, if SL DCI indicating initial transmission is received, it means that a new SL DCI scheduling indication is unlikely to be sent on a sidelink in a period of time from now on. Therefore, the user starts the SL bs-scheduled RTT timer, and the user can stop monitoring the SL DCI in the duration of the SL bs-scheduled RTT timer.

Exemplarily, for the RX UE, that is, for a case in which the SL DCI schedules the reception of the RX UE, if the RX UE feeds back the sidelink HARQ-ACK, the duration of the first wait-for-retransmission timer needs to at least include: a duration occupied by a process of SL DCI->RX UE completes reception of SL transmission corresponding to SL DCI->RX UE sends a PSFCH->RX UE PUCCH->Gnb. For example, the duration of the SL bs-scheduled RTT timer>=y1+time range occupied by the sidelink resource+K+N−1+y2.

In an example, the process of SL DCI->RX UE completes reception of all SL->RX UE PSFCH->RX UE PUCCH->Gnb includes: the RX UE receives SL DCI, and the RX UE performs SL transmission according to the SL DCI (for example, receives a PSSCH and a PSCCH), determines feedback information, and then sends the feedback information to the base station on a PUCCH.

In an example, in a case in which the SL DCI schedules reception of RX UE, if SL DCI indicating initial transmission is received, it means that a new SL DCI scheduling indication is unlikely to be transmitted on a sidelink in a period of time from now on. Therefore, the user starts the SL bs-scheduled RTT timer, and the user can stop monitoring the SL DCI in the duration of the SL bs-scheduled RTT timer (in some embodiments, this scheme is applicable to TX UE and RX UE are both bs-scheduled).

Exemplarily, the SL bs-scheduled RTT timer is started at the time of the last transmission of sidelink scheduling, and the duration of the SL bs-scheduled RTT timer is >=K+N−1+y2.

Exemplarily, the SL bs-scheduled RTT timer is started at the time of the PSFCH corresponding to the last transmission of the sidelink scheduling, and the SL bs-scheduled RTT timer is >=y2.

For example, in the embodiments of the present disclosure, the discontinuous transmission or reception configuration method provided in the embodiments of the present disclosure further includes the following steps:

Step A: When receiving SL DCI, or at a time of the first or last transmission of the sidelink grant, or at a time of a PSFCH corresponding to the first or last transmission of the sidelink grant, or when transmission or reception of the first UE fails, the first UE starts the wait-for-retransmission timer according to the target configuration information.

Exemplarily, the transmission failure of the first UE includes: the first UE fails to receive, or the first UE fails to send, or the first UE does not receive a feedback (for example, ACK) corresponding to successful transmission, or the first UE does not send a feedback (for example, ACK) corresponding to successful transmission.

For example, in the embodiments of the present disclosure, the discontinuous transmission or reception configuration method provided in the embodiments of the present disclosure further includes the following steps:

Step B: After the first retransmission timer is started, the first UE monitors a PDCCH.

Furthermore, in this embodiment of the present disclosure, the foregoing step B may include the following steps:

Step B1: After the first retransmission timer is started, the first UE monitors the SL DCI.

For example, in this embodiment of the present disclosure, the target configuration information includes at least one of the following: an activity timer, information of a discontinuous transmission or reception period of the target discontinuous transmission or reception mode, and offset information of the discontinuous transmission or reception period of the target discontinuous transmission or reception mode.

Exemplarily, for the first discontinuous transmission or reception mode (that is, the bs-scheduled Uu discontinuous transmission or reception mode) or the sidelink discontinuous transmission or reception mode (that is, the SL discontinuous transmission or reception mode), DRX is used as an example, and the target configuration information configures at least one of the following:

drx-onDurationTimerSL-bs-scheduled or drx-onDurationTimer-SL,

drx-InactivityTimerSL-bs-scheduled or drx-InactivityTimer-SL,

drxShortCycleTimerSL-bs-scheduled or drxShortCycleTimer-SL,

drx-LongCycleStartOffsetSL-bs-scheduled or drx-LongCycleStartOffset-SL,

drx-ShortCycleSL-bs-scheduled or drx-ShortCycle-SL, and

drx-SlotOffsetSL-bs-scheduled or drx_SlotOffset-SL.

The above drx-SlotOffsetSL-bs-scheduled or drx-SlotOffset-SL is the active timer or offset or cycle of the bs-scheduled Uu discontinuous transmission or reception mode or sidelink discontinuous transmission or reception mode.

drx-HARQ-RTT-Timer is a drx-wait-for-retransmission timer, drx-RetransmissionTimer is a drx-retransmission timer, drx-onDurationTimer is a drx-on duration timer, drx-InactivityTimer is a drx-active timer, and drxShortCycleTime is a drx-short cycle timer. A suffix of -SL indicates a timer of SL DRX, and a suffix of SL-bs-scheduled indicates a counter of the first discontinuous transmission or reception mode.

For example, in this embodiment of the present disclosure, each of the at least one carrier is configured with a different discontinuous transmission or reception mode, or the at least one carrier is configured with a same discontinuous transmission or reception configuration. For example, a discontinuous transmission or reception configuration is configured for each carrier, or a discontinuous transmission or reception configuration is configured for only a Primary Component Carrier (PCC) or a Synchronization Component Carrier (Synchronization CC). The Synchronization Component Carrier may be a carrier of a synchronization reference, or a carrier that can receive a synchronization signal, or a carrier that can send a synchronization signal.

Furthermore, in this embodiment of the present disclosure, in a case that the at least one carrier includes at least two carriers, at least one of the following information in discontinuous transmission or reception modes configured for the at least two carriers is the same: a duration of an on duration time in an active time (that is, on duration is a part of the active time, on duration), and a start point of the on duration time. For example, M carriers are configured, discontinuous transmission or receptions of N carriers of the M carriers are aligned, and N<=M.

For example, in this embodiment of the present disclosure, the active time of the target discontinuous transmission or reception mode includes: a timing duration of the retransmission timer.

Exemplarily, when the SL DRX mode is configured, the meaning of the active time includes any of the following:

1) the timing of the SL bs-scheduled retransmission timer or the timing of the running SL bs-scheduled retransmission timer (for example, drx-RetransmissionTimerSL-bs-scheduled). For example, when bs-scheduled Uu DRX mode is configured, the active time or SL bs-scheduled DRX active time includes: the duration of at least one of (running) drx-onDurationTimerSL-bs-scheduled, drx-InactivityTimerSL-bs-scheduled, drx-RetransmissionTimerSL-bs-scheduled, and ra-ContentionResolutionTimerSL-bs-scheduled.

Exemplarily, in this embodiment of the present disclosure, it may be further defined that a sidelink bs-scheduled DRX active time (sidelink bs-scheduled DRX active time) includes the duration of a (running) SL bs-scheduled retransmission timer (drx-RetransmissionTimerSL-bs-scheduled).

It should be noted that the network side device may not know this definition. Therefore, the network side device may still send SL DCI to the first UE, and the first UE cannot start the SL DCI RTT timer, which is different from the Uu DRX mode in the related art.

For example, in the embodiment of the present disclosure, in a case that the target discontinuous transmission or reception mode is the first discontinuous transmission or reception mode, the method provided by the embodiments of the present disclosure may further include the following steps:

Step 202a: In a case that a first condition is met, use, according to the target configuration information, at least one of a timer corresponding to the first discontinuous transmission or reception mode and a timer corresponding to the Uu discontinuous transmission or reception mode; and/or in a case that the first wait-for-retransmission timer expires, start the first retransmission timer according to the target configuration information; and/or in a case that a second condition is met, start or restart the activity timer according to the target configuration information.

The timer corresponding to the first discontinuous transmission or reception mode includes at least one of the following: a first wait-for-retransmission timer and a first retransmission timer. The timer corresponding to the Uu discontinuous transmission or reception mode includes at least one of the following: a second wait-for-retransmission timer and a second retransmission timer. The first condition includes any one of the following: a third condition, the first UE receives at least one of first SL DCI, and the first UE receives or sends information on one or more configured sidelink grants. The second condition includes any one of the following: the third condition and the first UE receives at least one of second DCI.

For example, the using the timer corresponding to the Uu discontinuous transmission or reception mode can be reusing the timer corresponding to the Uu discontinuous transmission or reception mode.

For example, the third condition includes: the first UE monitors the PDCCH.

In an example, the first UE monitors the PDCCH includes: the first UE monitors the PDCCH within the active time of the first discontinuous transmission or reception mode, and/or the first UE monitors the PDCCH scrambled by a sidelink RNTI. In a example, that the UE monitors the PDCCH includes: the first UE monitors, within the active time of the sidelink discontinuous transmission or reception mode, the PDCCH scrambled by a sidelink RNTI.

For example, the resource indicated by the first DCI is used for non-initial transmission.

For example, the second DCI indicates to activate a sidelink resource or deactivate a sidelink resource; or a resource indicated by the second DCI at least includes a resource for initial transmission. In an example, the resource indicated by the second DCI includes at least a resource used for initial transmission, and the resource indicated by the second DCI is also used to indicate to activate a sidelink resource.

Furthermore, in this embodiment of the present disclosure, the using the timer corresponding to the first discontinuous transmission or reception mode includes at least one of the following: starting the first wait-for-retransmission timer and stopping the first retransmission timer; and/or the reusing the timer corresponding to the Uu discontinuous transmission or reception mode includes at least one of the following: starting the second wait-for-retransmission timer and stopping the second retransmission timer.

Furthermore, in this embodiment of the present disclosure, in a case that the first UE receives or sends information on the configured sidelink grant, the starting the second wait-for-retransmission timer includes: starting the second wait-for-retransmission timer after delaying by a first predetermined time or offsetting by a first offset; and/or the stopping the second retransmission timer includes: stopping the second retransmission timer after delaying by a second predetermined time or offsetting by a second offset.

Furthermore, in this embodiment of the present disclosure, in a case that the first UE receives first DCI, the starting the second wait-for-retransmission timer includes: starting the second wait-for-retransmission timer after delaying by a third predetermined time or offsetting by a third offset; and/or the stopping the second retransmission timer includes: stopping the second retransmission timer after delaying by a fourth predetermined time or offsetting by a fourth offset.

Furthermore, in this embodiment of the present disclosure, the first predetermined time, the first offset, the second predetermined time, the second offset, the third predetermined time, the third offset, the fourth predetermined time, and the fourth offset may be preconfigured, specified in a protocol, or predefined. This may be set according to actual requirements and is not limited in this embodiment of the present disclosure.

Furthermore, in this embodiment of the present disclosure, the starting the target retransmission timer includes: starting the target retransmission timer for a target object corresponding to a target wait-for-retransmission timer; where the target object includes at least one of the following: a BWP, a resource pool, a link, a transmission, a feedback mechanism, a sidelink HARQ process, a downlink HARQ process, a sidelink grant, a destination ID, and a source ID. The target retransmission timer is the first retransmission timer and the target wait-for-retransmission timer is the first wait-for-retransmission timer; or the target retransmission timer is the second retransmission timer and the target wait-for-retransmission timer is the second wait-for-retransmission timer.

For example, after the first wait-for-retransmission timer expires, from a first symbol after the first wait-for-retransmission timer expires, the corresponding first retransmission timer is started for the target object corresponding to the first wait-for-retransmission timer.

For example, when the first UE receives or sends information on the configured sidelink grant, the user behavior of the first UE includes:

1) using at least one of the first wait-for-retransmission timer and the first retransmission timer.

A) start the waiting SL bs-scheduled HARQ retransmission timer (for example, drx-HARQ-RTT-TimerSL-bs-scheduled), that is, the first wait-for-retransmission timer.

For example, the waiting SL bs-scheduled HARQ retransmission timer corresponding to the target object of the sidelink transmission is started.

B) stopping the SL bs-scheduled retransmission timer (for example, drx-RetransmissionTimerSL-bs-scheduled), that is, the first retransmission timer.

2) reusing the timer corresponding to the existing Uu discontinuous transmission or reception.

A) starting the waiting Uu HARQ retransmission timer.

For example, the waiting Uu HARQ retransmission timer (for example, drx-HARQ-RTT-TimerUL) is started after delaying by the time delta 1 or the offset 1.

B) stopping the Uu retransmission timer.

For example, the Uu retransmission timer (for example, drx-RetransmissionTimerUL) is stopped after delaying by the time delta 2 or the offset 2.

For example, the SL bs-scheduled retransmission timer corresponding to the target object of the sidelink transmission is stopped.

For example, if the second SL DCI is received, the user behavior of the first UE includes: starting or restarting the drx-InactivityTimer. For example, the drx-InactivityTimer is started or restarted on the first symbol after the second SL DCI is received (the last symbol).

For example, if the first SL DCI is received, the user behavior of the first UE includes at least one of the following:

1) using at least one of the first wait-for-retransmission timer and the first retransmission timer.

A) start the waiting SL bs-scheduled HARQ retransmission timer (for example, drx-HARQ-RTT-TimerSL-bs-scheduled). For example, the corresponding waiting SL bs-scheduled HARQ retransmission timer is started for the target object (refer to the above description) corresponding to the first SL DCI. For example, the first SL DCI indicates that the HARQ process id=1, and the corresponding waiting SL bs-scheduled HARQ retransmission timer is started for HARQ process #1 on the first symbol after the SL transmission (the last symbol) scheduled by the first SL DCI.

B) stopping the SL bs-scheduled retransmission timer (for example, drx-RetransmissionTimerSL-bs-scheduled). For example, the SL bs-scheduled retransmission timer corresponding to the target object corresponding to the first SL DCI is stopped. For example, the first SL DCI indicates that the HARQ process id=1, and the SL bs-scheduled retransmission timer is stopped for HARQ process #1.

2) reusing the timer corresponding to the Uu discontinuous transmission or reception mode.

A) starting the waiting Uu HARQ retransmission timer (for example, drx-HARQ-RTT-TimerUL).

For example, the waiting drx-HARQ-RTT-TimerUL is started after delaying by the time delta 3 or the offset 3.

B) stopping the Uu retransmission timer (for example, drx-RetransmissionTimerUL).

For example, drx-RetransmissionTimerUL is stopped after delaying by the time delta 4 or the offset 4.

For example, in the embodiments of the present disclosure, in a case that the target discontinuous transmission or reception mode includes the first discontinuous transmission or reception mode or the sidelink discontinuous transmission or reception mode, the solution provided by the embodiments of the present disclosure further includes:

Step C: Perform at least one of the following operations:

performing sidelink Channel State Information (CSI) measurement during a first active time of the target discontinuous transmission or reception mode;

reporting a sidelink CSI report in a case of receiving a sidelink CSI-RS for channel measurement and/or CSI-IM for interference measurement within a second active time of the target discontinuous transmission or reception mode or not later than a second active time of the target discontinuous transmission or reception mode;

measuring a sidelink CSI-RS within an active time of the target discontinuous transmission or reception mode; and

expecting/considering/assuming that there is no sidelink CSI-RS outside the active time of the target discontinuous transmission or reception mode;

where the first active time is an active time in which the sidelink CSI report is reported; and the second active time is an active time in which a CSI reference resource is received.

Furthermore, in this embodiment of the present disclosure, reporting, by the first UE, a sidelink CSI report in a case of receiving a sidelink CSI-RS for channel measurement and/or CSI-IM for interference measurement within a second active time of the target discontinuous transmission or reception mode or not later than a second active time of the target discontinuous transmission or reception mode; otherwise, discarding the sidelink CSI report.

Furthermore, in this embodiment of the present disclosure, the active time of the target discontinuous transmission or reception mode is: a union set or an intersection set of the active time of the sidelink discontinuous transmission or reception mode and the active time of the Uu discontinuous transmission or reception mode, or the active time of the target discontinuous transmission or reception mode is: a union set or an intersection set of the active time of the first discontinuous transmission or reception mode and the active time of the Uu discontinuous transmission or reception mode.

For example, in this embodiment of the present disclosure, if the first UE uses the first transmission resource, or regardless of whether the first UE uses the target transmission resource, the working state of the first UE remains unchanged.

For example, in this embodiment of the present disclosure, if the first UE uses the target transmission resource, or regardless of whether the first UE uses the target transmission resource, the target transmission resource belongs to the active time, or the first UE is in the active time on the target transmission resource.

The target transmission resource is at least one transmission resource of the sidelink grant.

For example, at least one transmission resource of the configured sidelink grant is used as an example. When the first UE is in an active state (that is, the active time includes the configured sidelink grant), if the first UE actually uses the at least one transmission resource of the configured sidelink grant for transmission, the first UE is still in the active state; or regardless of whether the first UE actually uses at least one transmission resource of the configured sidelink grant for transmission, the first UE is in the active state, and in this case, if an RTT Timer runs, the RTT Timer is stopped.

For example, in the embodiments of the present disclosure, the discontinuous transmission or reception configuration method provided by the embodiments of the present disclosure may further include the following step:

Step C: If the first UE uses the target transmission resource, or regardless of whether the first UE uses the target transmission resource, start or restart the wait-for-retransmission timer.

For example, when the first UE starts or restarts the wait-for-retransmission timer, the first UE may not monitor the PDCCH or the sidelink grant within the timing time of the wait-for-retransmission timer.

The target transmission resource is at least one transmission resource of the sidelink grant.

For example, at least one transmission resource of the configured sidelink grant is used as an example. If the first UE actually uses the at least one transmission resource of the configured sidelink grant for transmission, the first UE starts or restarts the RTT Timer, and does not monitor a PDCCH or SL DCI within the time of the RTT Timer; or regardless of whether the first UE actually uses at least one transmission resource of the configured sidelink grant for transmission, the first UE starts or restarts the RTT Timer, and does not monitor a PDCCH or SL DCI within the time of the RTT Timer.

For example, in this embodiment of the present disclosure, the first UE may also report relevant information of the target discontinuous transmission or reception mode to the network side device. For example, the user reports bs-scheduled Uu DRX or SL DRX related information, such as reports a relevant Timer value that the user prefers or can accept or is interested in or supports.

In the discontinuous transmission or reception configuration method provided by the embodiments of the present disclosure, the target configuration information acquired by the first UE is used to configure the target discontinuous transmission or reception mode, and the target discontinuous transmission or reception mode includes the first discontinuous transmission or reception mode (that is, the Uu discontinuous transmission or reception mode used by a UE with a sidelink resource allocation mode) and the sidelink discontinuous transmission or reception mode. Therefore, the target discontinuous transmission or reception mode may be configured for the first UE based on the target configuration information, so as to perform transmission in the target discontinuous transmission or reception mode. This can meet a sidelink service requirement and a Uu service requirement at the same time, and improve the energy efficiency of a communication system.

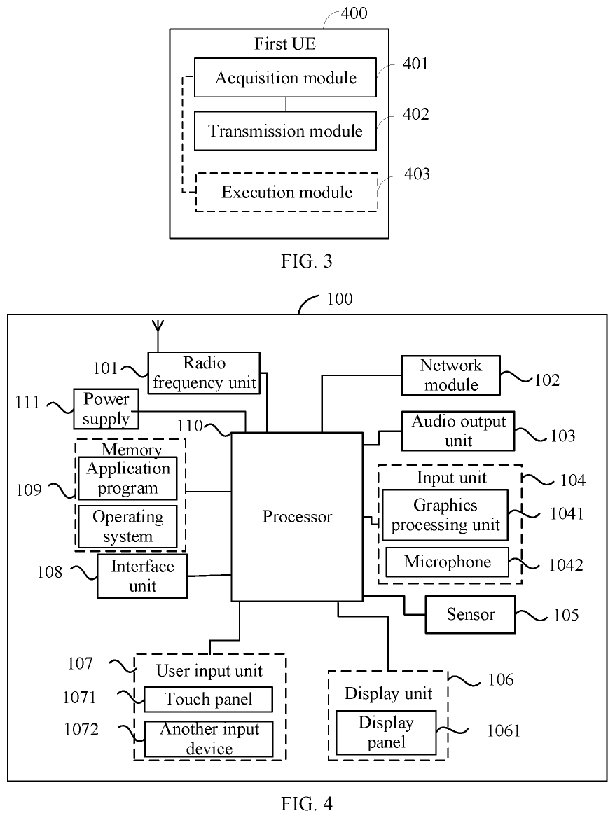

FIG. 3 is a schematic structural diagram of UE according to an embodiment of the present disclosure. The UE is first UE. As shown in FIG. 3, the first UE 400 includes an acquisition module 401 and a transmission module 402. The acquisition module 401 is configured to acquire target configuration information on at least one carrier; and the transmission module 402 is configured to perform transmission according to the target configuration information acquired by the acquisition module 401; where the target configuration information is used to configure a target discontinuous transmission or reception mode, the target discontinuous transmission or reception mode includes at least one of a first discontinuous transmission or reception mode and a sidelink discontinuous transmission or reception mode, and the first discontinuous transmission or reception mode is: a Uu discontinuous transmission or reception mode used by a UE with a sidelink resource allocation mode.

In some embodiments, the target configuration information includes at least one of the following: at least one wait-for-retransmission timer and at least one retransmission timer.

In some embodiments, the target configuration information is used to configure at least one of a wait-for-retransmission timer and a retransmission timer for each target object or each group of target objects. The target object includes at least one of the following: a carrier, a BWP, a resource pool, a link, a transmission, a feedback mechanism, a sidelink HARQ process, a downlink HARQ process, a sidelink grant, a destination ID, and a source ID.

In some embodiments, the wait-for-retransmission timer is a first wait-for-retransmission timer, and/or the retransmission timer is a first retransmission timer; where the first wait-for-retransmission timer and the first retransmission timer are timers corresponding to the first discontinuous transmission or reception mode.

In some embodiments, the timing of the wait-for-retransmission timer and/or the timing of the retransmission timer is related to at least one of the following:

a carrier,

a BWP,

a resource pool,

a transmission type,

a feedback mechanism,

the maximum number of transmissions of the sidelink grant,

the number of resources of the sidelink grant,

the actual number of transmissions of the sidelink grant,

the minimum time interval between a PSFCH corresponding to a sidelink resource and a corresponding PSSCH,

a transmission or reception period of the PSFCH,

the maximum number of transmissions scheduled by sidelink control information SCI,

the number of transmissions actually scheduled by the SCI,

the maximum number of retransmissions,

a resource preemption parameter

a priority,

a communication range,

a time delay,

reliability,

a channel busy ratio CBR,

a channel occupancy ratio CR,

a time range occupied by the sidelink resource,

sidelink resource configuration information,

sidelink resource indication information,

PUCCH configuration information, and

PUCCH indication information.

In some embodiments, the time range occupied by the sidelink resource is W slots or W milliseconds or W subframes, or the time range occupied by the sidelink resource is related to the maximum number of transmissions of the sidelink grant, or the time range occupied by the sidelink resource is a time resource span occupied by actual transmission of the sidelink grant, or the time range occupied by the sidelink resource is related to the maximum number of transmissions scheduled by the SCI, or the time range occupied by the sidelink resource is a time resource span occupied by the resource actually scheduled by the SCI; where W is a preset value.

In some embodiments, as shown in FIG. 3, the first UE 400 further includes: an execution module 403. The execution module 403 is configured to: when receiving DCI for scheduling a sidelink resource, or at a time of the first or last transmission of the sidelink grant, or at a time of a PSFCH corresponding to the first or last transmission of the sidelink grant, or when transmission or reception of the first UE fails, start the wait-for-retransmission timer according to the target configuration information.

In some embodiments, the execution module 403 is further configured to monitor the PDCCH after the first retransmission timer is started.

In some embodiments, the execution module 403 is configured to: monitor the DCI for scheduling a sidelink resource.

In some embodiments, the target configuration information includes at least one of the following: an activity timer, information of a discontinuous transmission or reception period of the target discontinuous transmission or reception mode, and offset information of the discontinuous transmission or reception period.

In some embodiments, a duration of the first wait-for-retransmission timer corresponding to the first discontinuous transmission or reception mode is not less than any one of the following: a duration from a time of the sidelink grant to a time of PUCCH transmission, or a duration from a time of activation signaling corresponding to the sidelink grant to a time of PUCCH transmission, or a duration from a time of the first or last transmission of the sidelink grant to a time of PUCCH transmission, or a duration from a time of a PSFCH corresponding to the first or last transmission of the sidelink grant to a time of PUCCH transmission.

In some embodiments, each of the at least one carrier is configured with a different discontinuous transmission or reception mode, or the at least one carrier is configured with a same discontinuous transmission or reception configuration.

In some embodiments, in a case that the at least one carrier includes at least two carriers, at least one of the following information in discontinuous transmission or reception modes configured for all or some of the at least two carriers is the same: a duration of an on duration time in an active time, and a start point of the on duration time.

In some embodiments, the active time of the target discontinuous transmission or reception mode includes: a timing duration of the retransmission timer.

In some embodiments, in a case that the target discontinuous transmission or reception mode is the first discontinuous transmission or reception mode, the execution module 403 is further configured to: in a case that a first condition is met, use, according to the target configuration information, at least one of a timer corresponding to the first discontinuous transmission or reception mode and a timer corresponding to the Uu discontinuous transmission or reception mode; and/or in a case that the first wait-for-retransmission timer expires, start the first retransmission timer according to the target configuration information; and/or in a case that a second condition is met, start or restart the activity timer according to the target configuration information.

The timer corresponding to the first discontinuous transmission or reception mode includes at least one of the following: a first wait-for-retransmission timer and a first retransmission timer. The timer corresponding to the Uu discontinuous transmission or reception mode includes at least one of the following: a second wait-for-retransmission timer and a second retransmission timer. The first condition includes any one of the following: a third condition, the first UE receives at least one of first DCI, and the first UE receives or sends information on the configured sidelink grant. The second condition includes any one of the following: the third condition and the first UE receives at least one of second DCI. The third condition includes: the first UE monitors the PDCCH. A resource indicated by the first DCI is used for non-initial transmission; and the second DCI indicates to activate a sidelink resource or deactivate a sidelink resource; or a resource indicated by the second DCI at least includes a resource for initial transmission.

In some embodiments, the using the timer corresponding to the first discontinuous transmission or reception mode includes at least one of the following: starting the first wait-for-retransmission timer and stopping the first retransmission timer; and/or the reusing the timer corresponding to the Uu discontinuous transmission or reception mode includes at least one of the following: starting the second wait-for-retransmission timer and stopping the second retransmission timer.

In some embodiments, in a case that the first UE receives or sends information on the configured sidelink grant, the starting the second wait-for-retransmission timer includes: starting the second wait-for-retransmission timer after delaying by a first predetermined time or offsetting by a first offset; and the stopping the second retransmission timer includes: stopping the second retransmission timer after delaying by a second predetermined time or offsetting by a second offset.

In some embodiments, in a case that the first UE receives first DCI, the starting the second wait-for-retransmission timer includes: starting the second wait-for-retransmission timer after delaying by a third predetermined time or offsetting by a third offset; and the stopping the second retransmission timer includes: stopping the second retransmission timer after delaying by a fourth predetermined time or offsetting by a fourth offset.

In some embodiments, the starting the target retransmission timer includes: starting the target retransmission timer for a target object corresponding to a target wait-for-retransmission timer; where the target object includes at least one of the following: a carrier, a BWP, a resource pool, a link, a transmission, a feedback mechanism, a sidelink HARQ process, a downlink HARQ process, a sidelink grant, a destination ID, and a source ID; and the target retransmission timer is the first retransmission timer and the target wait-for-retransmission timer is the first wait-for-retransmission timer; or the target retransmission timer is the second retransmission timer and the target wait-for-retransmission timer is the second wait-for-retransmission timer.

In some embodiments, in a case that the target discontinuous transmission or reception mode includes a first discontinuous transmission or reception mode or a sidelink discontinuous transmission or reception mode, the execution module is further configured to perform at least one of the following operations:

performing sidelink CSI measurement during a first active time of the target discontinuous transmission or reception mode;

reporting a sidelink CSI report in a case of receiving a sidelink CSI-RS for channel measurement and/or CSI-IM for interference measurement within a second active time of the target discontinuous transmission or reception mode or not later than a second active time of the target discontinuous transmission or reception mode;

measuring a sidelink CSI-RS within an active time of the target discontinuous transmission or reception mode; and

expecting that there is no sidelink CSI-RS outside the active time of the target discontinuous transmission or reception mode;

where the first active time is an active time in which the sidelink CSI report is reported; and the second active time is an active time in which a CSI reference resource is received.

In some embodiments, the active time of the target discontinuous transmission or reception mode is: a union set or an intersection set of the active time of the sidelink discontinuous transmission or reception mode and the active time of the Uu discontinuous transmission or reception mode, or the active time of the target discontinuous transmission or reception mode is: a union set or an intersection set of the active time of the first discontinuous transmission or reception mode and the active time of the Uu discontinuous transmission or reception mode.

In some embodiments, the target configuration information is configured by a network side device for the first UE, or specified by a protocol, or preconfigured, or indicated by second UE.

In some embodiments, the target configuration information is carried on at least one of the following signaling: configuration signaling of the Uu discontinuous transmission or reception mode, configuration signaling of the first discontinuous transmission or reception mode, and configuration signaling of the sidelink discontinuous transmission or reception mode.

In the first UE provided in the embodiments of the present disclosure, the target configuration information acquired by the first UE is used to configure the target discontinuous transmission or reception mode, and the target discontinuous transmission or reception mode includes the first discontinuous transmission or reception mode (that is, the Uu discontinuous transmission or reception mode used by a UE with a sidelink resource allocation mode) and the sidelink discontinuous transmission or reception mode. Therefore, the target discontinuous transmission or reception mode may be configured for the first UE based on the target configuration information, so as to perform transmission in the target discontinuous transmission or reception mode. This can meet a sidelink service requirement and a Uu service requirement at the same time, and improve the energy efficiency of a communication system.

The UE provided in the embodiments of the present disclosure can implement any process of the foregoing method embodiments. To avoid repetition, details are not described herein again.

For example, an embodiment of the present disclosure further provides UE, where the UE is first UE and the first UE includes a processor, a memory, and a computer program stored in the memory and executable on the processor. When the computer program is executed by the processor, the process of the discontinuous transmission or reception configuration method in the foregoing embodiment can be implemented, and a same technical effect can be achieved. To avoid repetition, details are not described herein again.

It should be noted that, as shown in FIG. 3, a module that must be included in the first UE 400 is indicated by a solid-line box, such as the acquisition module 401; and a module that may or may not be included in the first UE 400 is indicated by a dashed-line box, such as the execution module 403.

For example, the first UE is a terminal device. FIG. 4 is a schematic structural diagram of hardware of a terminal device implementing the embodiments of the present disclosure. The terminal device 100 includes but is not limited to: a radio frequency unit 101, a network module 102, an audio output unit 103, an input unit 104, a sensor 105, a display unit 106, a user input unit 107, an interface unit 108, a memory 109, a processor 110, a power supply 111, and other components. A person skilled in the art may understand that a structure of the terminal device 100 shown in FIG. 4 does not constitute a limitation on the terminal device, and the terminal device 100 may include more or fewer components than those shown in the figure, or combine some components, or have different component arrangements. In this embodiment of the present disclosure, the terminal device 100 includes but is not limited to a mobile phone, a tablet computer, a laptop computer, a palmtop computer, an in-vehicle terminal device, a wearable device, a pedometer, and the like.

The processor 110 is configured to acquire target configuration information on at least one carrier; and the radio frequency unit 101 is configured to perform transmission according to the target configuration information acquired by the processor 110; where the target configuration information is used to configure a target discontinuous transmission or reception mode, the target discontinuous transmission or reception mode includes at least one of a first discontinuous transmission or reception mode and a sidelink discontinuous transmission or reception mode, and the first discontinuous transmission or reception mode is: a Uu discontinuous transmission or reception mode used by a UE with a sidelink resource allocation mode.

In the terminal device provided by the embodiments of the present disclosure, the target configuration information acquired by the terminal device is used to configure the target discontinuous transmission or reception mode, and the target discontinuous transmission or reception mode includes the first discontinuous transmission or reception mode (that is, the Uu discontinuous transmission or reception mode used by a UE with a sidelink resource allocation mode) and the sidelink discontinuous transmission or reception mode. Therefore, the target discontinuous transmission or reception mode may be configured for the terminal device based on the target configuration information, so as to perform transmission in the target discontinuous transmission or reception mode. This can meet a sidelink service requirement and a Uu service requirement at the same time, and improve the energy efficiency of a communication system.

It should be understood that, in this embodiment of the present disclosure, the radio frequency unit 101 may be configured to receive and send information or receive and send a signal in a call process. In some embodiments, after downlink data from a base station is received, the processor 110 processes the downlink data. In addition, uplink data is sent to the base station. Usually, the radio frequency unit 101 includes but is not limited to an antenna, at least one amplifier, a transceiver, a coupler, a low noise amplifier, a duplexer, and the like. In addition, the radio frequency unit 101 may communicate with a network and another device through a wireless communication system.

The terminal device 100 provides wireless broadband Internet access for the user by using the network module 102, for example, helping the user send and receive an e-mail, browse a web page, and access streaming media.

The audio output unit 103 may convert audio data received by the radio frequency unit 101 or the network module 102 or stored in the memory 109 into an audio signal, and output the audio signal as sound. In addition, the audio output unit 103 may further provide audio output (for example, call signal receiving sound or message receiving sound) related to a specific function performed by the terminal device 100. The audio output unit 103 includes a speaker, a buzzer, a telephone receiver, and the like.

The input unit 104 is configured to receive an audio signal or a video signal. The input unit 104 may include a Graphics Processing Unit (GPU) 1041 and a microphone 1042. The graphics processing unit 1041 processes image data of a static picture or a video obtained by an image capturing apparatus (for example, a camera) in a video capturing mode or an image capturing mode. A processed image frame may be displayed on the display unit 106. The image frame processed by the graphics processing unit 1041 may be stored in the memory 109 (or another storage medium) or sent via the radio frequency unit 101 or the network module 102. The microphone 1042 may receive a sound and can process such sound into audio data. Processed audio data may be converted, in a call mode, into a format that can be sent to a mobile communication base station by using the radio frequency unit 101 for output.

The terminal device 100 further includes at least one sensor 105, such as an optical sensor, a motion sensor, and other sensors. In some embodiments, the light sensor includes an ambient light sensor and a proximity sensor. The ambient light sensor may adjust luminance of the display panel 1061 based on brightness of ambient light. The proximity sensor may turn off the display panel 1061 and/or backlight when the terminal device 100 is moved to an ear. As a type of the motion sensor, an accelerometer sensor may detect an acceleration value in each direction (generally, three axes), and detect a value and a direction of gravity when the accelerometer sensor is static, and may be used in an application for recognizing a posture of the terminal device (such as screen switching between landscape and portrait modes, a related game, or magnetometer posture calibration), a function related to vibration recognition (such as a pedometer or a knock), and the like. The sensor 105 may further include a fingerprint sensor, a pressure sensor, an iris sensor, a molecular sensor, a gyroscope, a barometer, a hygrometer, a thermometer, an infrared sensor, and the like. Details are not described herein.

The display unit 106 is configured to display information input by a user or information provided for a user. The display unit 106 may include a display panel 1061. The display panel 1061 may be configured in a form of a Liquid Crystal Display (LCD), an Organic Light-Emitting Diode (OLED), or the like.

The user input unit 107 may be configured to receive input numeral or character information, and generate key signal input related to user setting and function control of the terminal device 100. In some embodiments, the user input unit 107 includes a touch panel 1071 and another input device 1072. The touch panel 1071 is also referred to as a touchscreen, and may collect a touch operation performed by a user on or near the touch panel (such as an operation performed by a user on the touch panel 1071 or near the touch panel 1071 by using any proper object or accessory, such as a finger or a stylus). The touch panel 1071 may include two parts: a touch detection apparatus and a touch controller. The touch detection apparatus detects a touch location of the user, detects a signal brought by the touch operation, and sends the signal to the touch controller. The touch controller receives touch information from the touch detection apparatus, converts the touch information into touch point coordinates, and sends the touch point coordinates to the processor 110, and receives and executes a command sent by the processor 110. In addition, the touch panel 1071 may be implemented by using a plurality of types such as a resistive type, a capacitive type, an infrared ray, and a surface acoustic wave. The user input unit 107 may include other input devices 1072 in addition to the touch panel 1071. In some embodiments, the another input device 1072 may include but is not limited to: a physical keyboard, a function key (such as a volume control key, a switch key), a trackball, a mouse, and a joystick, which is no longer repeated here.

Further, the touch panel 1071 may cover the display panel 1061. When detecting a touch operation on or near the touch panel 1071, the touch panel transmits the touch operation to the processor 110 to determine a type of a touch event. Then the processor 110 provides corresponding visual output on the display panel 1061 based on the type of the touch event. In FIG. 4, the touch panel 1071 and the display panel 1061 are used as two independent components to implement input and output functions of the terminal device 100. However, in some embodiments, the touch panel 1071 and the display panel 1061 may be integrated to implement the input and output functions of the terminal device 100. This is not specifically limited herein.

The interface unit 108 is an interface for connecting an external apparatus to the terminal device 100. For example, the external apparatus may include a wired or wireless headset jack, an external power supply (or a battery charger) port, a wired or wireless data port, a storage card port, a port for connecting an apparatus having an identification module, an audio Input/Output (I/O) port, a video I/O port, a headset jack, or the like. The interface unit 108 may be configured to receive input (for example, data information and power) from an external apparatus and transmit the received input to one or more elements in the terminal device 100 or may be configured to transmit data between the terminal device 100 and the external apparatus.

The memory 109 may be configured to store a software program and various data. The memory 109 may mainly include a program storage area and a data storage area. The program storage area may store an operating system, an application program required by at least one function (such as a sound play function or an image play function), and the like. The data storage area may store data (such as audio data or an address book) or the like created based on use of the mobile phone. In addition, the memory 109 may include a high-speed random access memory, and may further include a nonvolatile memory, for example, at least one magnetic disk storage device, a flash storage device, or another volatile solid-state storage device.

The processor 110 is a control center of the terminal device 100, uses various interfaces and circuits to connect each part of the whole terminal device 100, and performs various functions and processing data of the terminal device 100 by operating or executing a software program and/or module in the memory 109 and calling data stored in the memory 109, so as to integrally monitor the terminal device 100. The processor 110 may include one or more processing units. In some embodiments, an application processor and a modem processor may be integrated into the processor 110. The application processor mainly processes an operating system, a user interface, an application program, and the like. The modem processor mainly processes wireless communications. It can be understood that, in some embodiments, the modem processor may not be integrated into the processor 110.

The terminal device 100 may further include the power supply 111 (such as a battery) that supplies power to each component. In some embodiments, the power supply 111 may be logically connected to the processor 110 by using a power management system, to implement functions such as charging, discharging, and power consumption management by using the power management system.

In addition, the terminal device 100 includes some function modules not shown. Details are not described herein.

An embodiment of the present disclosure further provides a computer-readable storage medium. A computer program is stored in the computer-readable storage medium. When the computer program is executed by a processor, a plurality of processes of the discontinuous transmission or reception configuration method in the foregoing embodiment are implemented, and same technical effects can be achieved. To avoid repetition, details are not described herein. The computer readable storage medium includes a Read-Only Memory (ROM), a Random Access Memory (RAM), a magnetic disk, an optical disc, or the like.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of more restrictions, an element defined by the statement “including a . . . ” does not exclude another same element in a process, method, article, or apparatus that includes the element.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of the present disclosure essentially or the part contributing to the prior art may be implemented in a form of a software product. The computer software product is stored in a storage medium (such as a ROM/RAM, a magnetic disk, or an optical disc), and includes several instructions for instructing a terminal (which may be a mobile phone, a computer, a server, an air conditioner, a network side device, or the like) to perform the methods described in the embodiments of the present disclosure.

The embodiments of the present disclosure are described with reference to the accompanying drawings. However, the present disclosure is not limited to the foregoing specific implementations. The foregoing specific implementations are merely examples, but are not limiting. A person of ordinary skill in the art may make many forms without departing from the objective and the scope of the claims of the present disclosure, and these forms all fall within the protection scope of the present disclosure.

1. A discontinuous transmission or reception configuration method, performed by a first User Equipment (UE), wherein the method comprises:
acquiring target configuration information on at least one carrier; and
performing transmission according to the target configuration information;
wherein the target configuration information is used to configure a target discontinuous transmission or reception mode, the target discontinuous transmission or reception mode comprises at least one of a first discontinuous transmission or reception mode and a sidelink discontinuous transmission or reception mode, and the first discontinuous transmission or reception mode is: an air interface (Uu) discontinuous transmission or reception mode used by a UE with a sidelink resource allocation mode.

2. The method according to claim 1, wherein the target configuration information comprises at least one of the following: at least one wait-for-retransmission timer, or at least one retransmission timer.

3. The method according to claim 2, wherein the target configuration information is used to configure at least one of a wait-for-retransmission timer and a retransmission timer for each target object or each group of target objects;
wherein the target object comprises at least one of the following:
a carrier, a BandWidth Part (BWP), a resource pool, a link, a transmission or reception, a feedback mechanism, a sidelink Hybrid Automatic Repeat reQuest (HARQ) process, a downlink HARQ process, a sidelink grant, a destination IDentifier (ID), or a source ID.

4. The method according to claim 2, wherein the wait-for-retransmission timer is a first wait-for-retransmission timer, or the retransmission timer is a first retransmission timer; and
the first wait-for-retransmission timer and the first retransmission timer are timers corresponding to the first discontinuous or reception transmission mode.

5. The method according to claim 2, wherein the timing of the wait-for-retransmission timer or the timing of the retransmission timer is related to at least one of the following:
a carrier;
a BandWidth Part (BWP);
a resource pool;
a transmission type;
a feedback mechanism;
the maximum number of transmissions of the sidelink grant;
the number of resources of the sidelink grant;
the actual number of transmissions of the sidelink grant;
the minimum time interval between a Physical Sidelink Feedback CHannel (PSFCH) corresponding to a sidelink resource and a corresponding Physical Sidelink Shared CHannel (PSSCH);
a transmission or reception period of the PSFCH;
the maximum number of transmissions scheduled by Sidelink Control Information (SCI);
the number of transmissions actually scheduled by the SCI;
the maximum number of retransmissions;
a resource preemption parameter;
a priority;
a communication range;
a time delay;
reliability;
a Channel Busy Ratio (CBR);
a Channel occupancy Ratio (CR);
a time range occupied by the sidelink resource;
sidelink resource configuration information;
sidelink resource indication information;
physical uplink control channel PUCCH configuration information; or PUCCH indication information;
wherein the time range occupied by the sidelink resource is:
W slots or W milliseconds or W subframes;
related to the maximum number of transmissions of the sidelink grant;
a time resource span occupied by actual transmission of the sidelink grant;
related to the maximum number of transmissions scheduled by the SCI; or
a time resource span occupied by the resource actually scheduled by the SCI; wherein W is a preset value.

6. The method according to claim 2, wherein after the acquiring target configuration information on at least one carrier, the method further comprises:
when receiving Downlink Control Information (DCI) for scheduling a sidelink resource, or at a time of the first or last transmission of the sidelink grant, or at a time of a PSFCH corresponding to the first or last transmission of the sidelink grant, or when transmission or reception of the first UE fails, starting the wait-for-retransmission timer according to the target configuration information.

7. The method according to claim 4, wherein the method further comprises:
after the first retransmission timer is started, monitoring a Physical Downlink Control CHannel (PDCCH).

8. The method according to claim 2, wherein a duration of the first wait-for-retransmission timer corresponding to the first discontinuous transmission or reception mode is not less than any one of the following:
a duration from a time of the sidelink grant to a time of PUCCH transmission;
a duration from a time of activation signaling corresponding to the sidelink grant to a time of PUCCH transmission;
a duration from a time of the first or last transmission of the sidelink grant to a time of PUCCH transmission; or
a duration from a time of a PSFCH corresponding to the first or last transmission of the sidelink grant to a time of PUCCH transmission.

9. The method according to claim 1, wherein in a case that the target discontinuous transmission or reception mode is the first discontinuous transmission or reception mode, after the acquiring target configuration information on at least one carrier, the method further comprises:
in a case that a first condition is met, using, according to the target configuration information, at least one of a timer corresponding to the first discontinuous transmission or reception mode and a timer corresponding to the Uu discontinuous transmission or reception mode;
in a case that the first wait-for-retransmission timer expires, starting the first retransmission timer according to the target configuration information; and
in a case that a second condition is met, starting or restarting the activity timer according to the target configuration information;
wherein the timer corresponding to the first discontinuous transmission or reception mode comprises at least one of the following: a first wait-for-retransmission timer or a first retransmission timer; and the timer corresponding to the Uu discontinuous transmission or reception mode comprises at least one of the following:
a second wait-for-retransmission timer or a second retransmission timer;
the first condition comprises any one of the following: a third condition, the first UE receives at least one of first Downlink Control Information (DCI), or the first UE receives or sends information on a configured sidelink grant;
the second condition comprises any one of the following: the third condition or the first UE receives at least one of second DCI;
the third condition comprises: the first UE monitors a Physical Downlink Control CHannel (PDCCH); and
a resource indicated by the first DCI is used for non-initial transmission; the second DCI indicates to activate a sidelink resource or deactivate a sidelink resource; or a resource indicated by the second DCI at least comprises a resource for initial transmission.

10. The method according to claim 1, wherein in a case that the target discontinuous transmission or reception mode comprises a first discontinuous transmission or reception mode or a sidelink discontinuous transmission or reception mode, the method further comprises:
performing at least one of the following operations:
performing sidelink Channel State Information (CSI) measurement during a first active time of the target discontinuous transmission or reception mode;
reporting a sidelink CSI report in a case of receiving a sidelink Channel State Information Reference Signal (CSI-RS) for channel measurement or Channel State Information Interference Measurement (CSI-IM) for interference measurement within a second active time of the target discontinuous transmission or reception mode or not later than a second active time of the target discontinuous transmission or reception mode;
measuring a sidelink CSI-RS within an active time of the target discontinuous transmission or reception mode; and
expecting that there is no sidelink CSI-RS outside the active time of the target discontinuous transmission or reception mode;
wherein the first active time is an active time in which the sidelink CSI report is reported; and the second active time is an active time in which a CSI reference resource is received.

11. A first User Equipment (UE), comprising:
a memory storing computer-readable instructions; and
a processor coupled to the memory and configured to execute the computer-readable instructions, wherein the computer-readable instructions, when executed by the processor, cause the processor to perform operations comprising:
acquiring target configuration information on at least one carrier; and
performing transmission according to the target configuration information;
wherein the target configuration information is used to configure a target discontinuous transmission or reception mode, the target discontinuous transmission or reception mode comprises at least one of a first discontinuous transmission or reception mode and a sidelink discontinuous transmission or reception mode, and the first discontinuous transmission or reception mode is: an air interface (Uu) discontinuous transmission or reception mode used by a UE with a sidelink resource allocation mode.

12. The first UE according to claim 11, wherein the target configuration information comprises at least one of the following: at least one wait-for-retransmission timer, or at least one retransmission timer.

13. The first UE according to claim 12, wherein the target configuration information is used to configure at least one of a wait-for-retransmission timer and a retransmission timer for each target object or each group of target objects;
wherein the target object comprises at least one of the following:
a carrier, a BandWidth Part (BWP), a resource pool, a link, a transmission or reception, a feedback mechanism, a sidelink Hybrid Automatic Repeat reQuest (HARQ) process, a downlink HARQ process, a sidelink grant, a destination IDentifier (ID), or a source ID.

14. The first UE according to claim 12, wherein the wait-for-retransmission timer is a first wait-for-retransmission timer, or the retransmission timer is a first retransmission timer; and
the first wait-for-retransmission timer and the first retransmission timer are timers corresponding to the first discontinuous or reception transmission mode.

15. The first UE according to claim 12, wherein the timing of the wait-for-retransmission timer or the timing of the retransmission timer is related to at least one of the following:
a carrier;
a BandWidth Part (BWP);
a resource pool;
a transmission type;
a feedback mechanism;
the maximum number of transmissions of the sidelink grant;
the number of resources of the sidelink grant;
the actual number of transmissions of the sidelink grant;
the minimum time interval between a Physical Sidelink Feedback CHannel (PSFCH) corresponding to a sidelink resource and a corresponding Physical Sidelink Shared CHannel (PSSCH);
a transmission or reception period of the PSFCH;
the maximum number of transmissions scheduled by Sidelink Control Information (SCI);
the number of transmissions actually scheduled by the SCI;
the maximum number of retransmissions;
a resource preemption parameter;
a priority;
a communication range;
a time delay;
reliability;
a Channel Busy Ratio (CBR);
a Channel occupancy Ratio (CR);
a time range occupied by the sidelink resource;
sidelink resource configuration information;
sidelink resource indication information;
physical uplink control channel PUCCH configuration information; or
PUCCH indication information;
wherein the time range occupied by the sidelink resource is:
W slots or W milliseconds or W subframes;
related to the maximum number of transmissions of the sidelink grant;
a time resource span occupied by actual transmission of the sidelink grant;
related to the maximum number of transmissions scheduled by the SCI; or
a time resource span occupied by the resource actually scheduled by the SCI; wherein W is a preset value.

16. The first UE according to claim 12, wherein after the acquiring target configuration information on at least one carrier, the operations further comprise:
when receiving Downlink Control Information (DCI) for scheduling a sidelink resource, or at a time of the first or last transmission of the sidelink grant, or at a time of a PSFCH corresponding to the first or last transmission of the sidelink grant, or when transmission or reception of the first UE fails, starting the wait-for-retransmission timer according to the target configuration information.

17. The first UE according to claim 14, wherein the operations further comprise:
after the first retransmission timer is started, monitoring a Physical Downlink Control CHannel (PDCCH).

18. The first UE according to claim 12, wherein a duration of the first wait-for-retransmission timer corresponding to the first discontinuous transmission or reception mode is not less than any one of the following:
a duration from a time of the sidelink grant to a time of PUCCH transmission;
a duration from a time of activation signaling corresponding to the sidelink grant to a time of PUCCH transmission;
a duration from a time of the first or last transmission of the sidelink grant to a time of PUCCH transmission; or
a duration from a time of a PSFCH corresponding to the first or last transmission of the sidelink grant to a time of PUCCH transmission.

19. The first UE according to claim 11, wherein in a case that the target discontinuous transmission or reception mode is the first discontinuous transmission or reception mode, after the acquiring target configuration information on at least one carrier, the operations further comprise:
in a case that a first condition is met, using, according to the target configuration information, at least one of a timer corresponding to the first discontinuous transmission or reception mode and a timer corresponding to the Uu discontinuous transmission or reception mode;
in a case that the first wait-for-retransmission timer expires, starting the first retransmission timer according to the target configuration information; and
in a case that a second condition is met, starting or restarting the activity timer according to the target configuration information;
wherein the timer corresponding to the first discontinuous transmission or reception mode comprises at least one of the following: a first wait-for-retransmission timer or a first retransmission timer; and the timer corresponding to the Uu discontinuous transmission or reception mode comprises at least one of the following:
a second wait-for-retransmission timer or a second retransmission timer;
the first condition comprises any one of the following: a third condition, the first UE receives at least one of first Downlink Control Information (DCI), or the first UE receives or sends information on a configured sidelink grant;
the second condition comprises any one of the following: the third condition or the first UE receives at least one of second DCI;
the third condition comprises: the first UE monitors a Physical Downlink Control CHannel (PDCCH); and
a resource indicated by the first DCI is used for non-initial transmission; the second DCI indicates to activate a sidelink resource or deactivate a sidelink resource; or a resource indicated by the second DCI at least comprises a resource for initial transmission.

20. A non-transitory computer readable medium storing instructions that, when executed by a processor, cause the processor to perform a discontinuous transmission or reception configuration method, wherein the method comprises:
acquiring target configuration information on at least one carrier; and
performing transmission according to the target configuration information;
wherein the target configuration information is used to configure a target discontinuous transmission or reception mode, the target discontinuous transmission or reception mode comprises at least one of a first discontinuous transmission or reception mode and a sidelink discontinuous transmission or reception mode, and the first discontinuous transmission or reception mode is: an air interface (Uu) discontinuous transmission or reception mode used by a User Equipment (UE) with a sidelink resource allocation mode.
